(19) United States
(12) Patent Application Publication
(10) Pub. No.: US 2012/0145955 A1
(43) Pub. Date: Jun. 14, 2012

(54) COMPOSITION OF HCFO-1233zd AND POLYOL BLENDS FOR USE IN POLYURETHANE FOAM

(75) Inventors: Laurent Abbas, Narberth, PA (US); Joseph Costa, Gilbertsville, PA (US); Benjamin Bin Chen, Wayne, PA (US)

(73) Assignee: Arkema Inc., King of Prussia, PA (US)

(21) Appl. No.: 13/386,056

(22) PCT Filed: Jul. 26, 2010
(86) PCT No.: PCT/US10/43191

§ 371 Date: Jan. 20, 2012

Related U.S. Application Data
(60) Provisional application No. 61/228,748, filed on Jul. 27, 2009.

(51) Int. Cl. C09K 3/00

(52) U.S. Cl. 252/182.15

(57) ABSTRACT

The HCFO-1233zd polyurethane foam blowing agent is mixed with polyol blends consisting of at least one polyether polyol and at leas one polyester polyol. The combination is useful in producing polyurethane, thermosetting foams. Polyurethane foams are useful in applications such as thermal insulation in appliances, and residential and commercial buildings.

### FIELD OF THE INVENTION

The present invention relates to polyol and blowing agent blends for thermosetting foams. More particularly, the present invention relates to the blends of HCFO-1233zd (trifluoro-monochloropropenes) alone or in a blowing agent combination with one or more polyols which combination is used in the manufacture of thermosetting foams.

### BACKGROUND OF THE INVENTION

The Montreal Protocol for the protection of the ozone layer mandated the phase out of the use of chlorofluorocarbons (CFCs). Materials more “friendly” to the ozone layer, such as hydrofluorocarbons (HFCs) replaced chlorofluorocarbons. The latter compounds have proven to be green house gases, causing global warming and were regulated by the Kyoto Protocol on Climate Change. The emerging replacement materials, hydrofluoropropenes, were shown to be environmentally acceptable i.e. has zero ozone depletion potential (ODP) and acceptable low global warming potential (GWP).

Currently, blowing agents for thermoset foams include HFC-134a, HFC-245fa, HFC-365mfc, HFC-141a that have relatively high global warming potential, and hydrocarbons such as pentane isomers which are flammable and have low energy efficiency. Therefore, new alternative blowing agents are being sought. Halogenated hydroolefinic materials such as hydrofluoropropenes and/or hydrochlorofluoropropenes have generated interest as replacements for HFCs. The inherent chemical instability of these materials in the lower atmosphere provides the low global warming potential and zero or near zero ozone depletion properties desired.

The object of the present invention is to provide novel compositions of HCFO-1233 and polyols used for producing thermosetting foams and thermosetting foams made therefrom that provide unique characteristics to meet the demands of low or zero ozone depletion potential, lower global warming potential and exhibit low toxicity.

### BRIEF DESCRIPTION OF THE DRAWINGS

FIG. 1 is a graph of Vapor Pressure versus Part of Blowing Agent per 100 part of polyol by weight

### DETAILED DESCRIPTION OF THE INVENTION

The present invention is directed towards HCFO-1233zd (as a polyurethane foam blowing agent) mixed into polyol blends consisting of at least one polyether polyol and at least one polyester polyol. The blend of polyether polyols and polyester polyols can vary in a ratio of from 1:99 and 99:1 with the HCFO-1233zd blowing agent. The HCFO-1233zd is preferably, predominately the trans isomer of HCFO-1233zd. The combination of the present invention was discovered to provide for good solubility of the blowing agent in the polyol mixture which is useful in producing polyurethane and polyisocyanurate foams.

It is preferred that a major portion of HCFO-1233zd blowing agent component of the present invention is the trans isomer. It was discovered that the trans isomer exhibits a significantly lower genotoxicity in AMES testing than the cis isomer. A preferred ratio of trans and cis isomers of 1233zd is less than about 30% weight of the combination of the cis isomer, and preferably less than about 10% of the cis isomer. The most preferred ratio is less than about 3% of the cis isomer.

The preferred combination of a blend of polyether polyols and polyester polyols with the HCFO-1233zd blowing agent produces foam having desirable levels of insulating value. HCFO-1233zd was evaluated in different ratio of polyether polyols and polyester polyols and benchmarked against HCFC141 b and HFC245fa. It is known to the people skilled in the art that HFC245fa is relatively less soluble in polyols while HCFC141b is much more soluble; HCFO-1233zd solubility falls in between HFC245fa and HCFC141b. It was surprisingly discovered that HCFO-1233zd allows a significantly wider window of selection of polyether polyols and polyester polyols, which is essential for safe handling, transportation and storage of polyol blends, and use of resulted foam.

The polyether polyols of the present invention can include, glycerin based polyether polyols such as Carpol GP-700, GP-725, GP-4000, GP-4520; amine based polyether polyols such as Carpol TEAP-265 and EDAP-770, Jeffol AD-310; sucrose based polyether polyol, such as Jeffol SD-360, SG-361, and SD-522, Voranol 490, Carpol SPA-357; Mannich base polyether polyol such as Jeffol R-425X and R-470X:; Sorbitol based polyether polyol such as Jeffol S-490, bio-based polyether polyol such as RENUVA series, BiOH polyols, and JEFFADD.

The polyester polyols of the present invention can include; aromatic polyester polyols such as Terate 2541 and 3510, Stepanol PS-2352, Terol TR-925, and aliphatic polyester polyols. A typical combination in accordance with the present invention comprises HCFO-1233zd blowing agent and a polyol combination of polyester polyol(s) and polyether polyol(s) in a ratio of polyester polyol(s) to polyether polyol(s) of between 1:99 and 99:1.

It is contemplated that in certain embodiments of the present invention the HCFO-1233zd blowing agent is present as a blowing agent without the presence of any substantial amount of additional components. However, one or more optional compounds or components that are not within the scope of the above described combination of the present invention are included in the combination of the present invention. Such optional additional compounds include, but are not limited to, other compounds which also act as blowing agents (hereinafter referred to for convenience but not by way of limitation as co-blowing agents), surfactants, polymer modifiers, toughening agents, colorants, dyes, solubility enhancers, rheology modifiers, plasticizing agents, flammability suppressants, antibacterial agents, viscosity reduction modifiers, fillers, vapor pressure modifiers, nucleating agents, catalysts and the like. In certain preferred embodiments, dispersing agents, cell stabilizers, surfactants and other additives may also be incorporated into the combination of the present invention.

The composition of the present invention is useful in polyurethane (PUR) and polyisocyanate (PIR) foam applications that are known to those skilled in the art including but not limited to spray, appliance, water heater, entry door, garage door, panel, boardstock, etc. In particular, the combination of the present invention is useful in PUR and PIR foam applications wherein the blowing agent is pre-blended into polyol mixtures such as spray foam applications.

### EXAMPLES

### Solubility Experiments

The vapor pressure of a foam blowing agent in polyurethane materials was evaluated in an experimental apparatus consisting of a pressure vessel with magnetic stirring, a pressure transducer and a temperature transducer. The temperature inside the vessel was controlled within 0.1° C. and the pressure controlled to within 0.1%.

Into the pressure vessel (volume about 100 ml), 50 g of polyol was loaded. The vessel was then placed under vacuum to remove air. The change of pressure in the metal cylinder was monitored to ensure that there were no leaks. The blowing agent was introduced into the vessel by the use of a specially designed gas syringe. The amount of blowing agent loaded was verified by measuring the weight of the syringe before and after introduction. The temperature of the vessel was maintained at 50° C. (above the boiling point of the blowing agents being tested) and the speed of the shaker was maintained at 300 rpm. The vapor pressure of the blowing agent was recorded as a function of the time. Sufficient time was allowed for the system to reach equilibrium. After reaching equilibrium, the amount of blowing agent dissolved in the polyol was calculated as the difference between the added blowing agent present in the polyol and the blowing agent present in the gas phase of the vessel.

Then another small amount of blowing agent was added in the vessel. The procedure was repeated several times until the pressure in the vessel was equal to the liquid-gas equilibrium vapor pressure of the blowing agent at this temperature (maximum attainable pressure at temperatures below the critical temperature of the blowing agent).

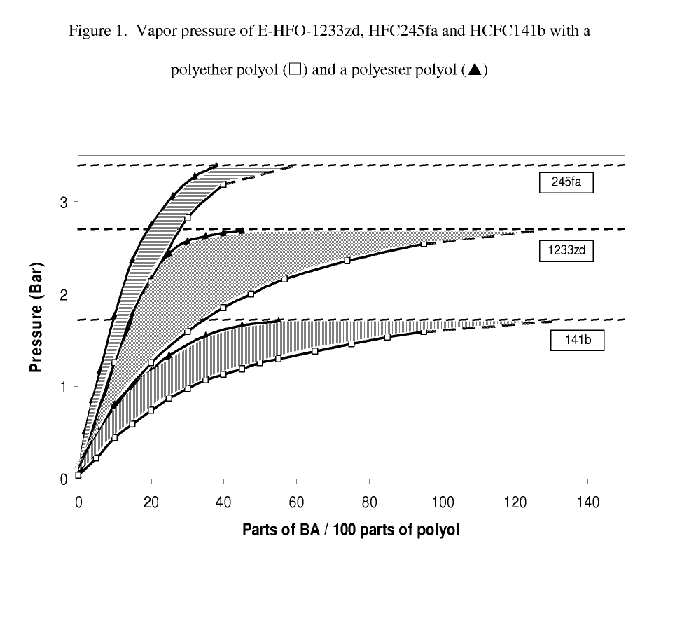

FIG. 1 shows the vapor pressure of E-HCFO-1233zd, 245fa and 141b with two different polyols a polyether poly and a polyester polyol. For each blowing agent the increase of the vapor pressure is dependant on the nature of the polyol. The vapor pressure will increase gradually with the blowing agent concentration when the affinity is high (e.g polyether polyol); conversely, when affinity is low, vapor pressure increases more quickly at lower blowing agent concentrations (e.g polyester polyol).

For a polyol compositions using a combination of a polyether polyol and a polyester polyol, the vapor pressure will therefore be somewhere in the area between the two curves. The figure shows that the solubility curves for the polyether polyol and the polyester polyol with E-HCFO-1233zd are between those for HFC245fa and HCFC141b indicating that E-HCFO-1233zd exhibits solubility comparable to current blowing agents. FIG. 2 also shows that the area between the curves (shaded) is significantly larger for E-HCFO-1233zd than for HCFC141b and HFC245fa. This indicates a significantly wider range of solubilities for E-HCFO-1233zd, which allows for enhanced flexibility when designing a foam system containing a combination of polyether polyols and polyester polyols.

1. A composition comprising HCFO-1233zd and a polyol blend comprising at least one polyester polyol and at least one polyether polyol wherein the ratio of polyester polyol to polyether polyol is between 1:99 and 99:1

2. The composition of claim 1 wherein said polyether polyol is selected from the group consisting of glycerin based polyether polyols, amine based polyether polyols, sucrose based polyether polyol, mannich base polyether polyol, Sorbitol based polyether polyol, bio-based polyether polyol and BiOH polyols.

3. The composition of claim 1 wherein said polyester polyol is selected from the group consisting of aromatic polyester polyols and aliphatic polyester polyols.

4. The composition of claim 1 wherein said HCFO-1233zd comprises about 90 wt % or more the trans stereoisomer.

5. The composition of claim 1 wherein said HCFO-1233zd comprises about 97 wt % or more the trans stereoisomer.

6. The composition of claim 1, further comprising an additional blowing agent selected from the group consisting of hydrofluorocarbons, hydrofluoroolefins, hydrochlorofluoroolefins and mixtures thereof.

7. A thermosetting foamable composition comprising a polyester polyol, a polyether polyol and a trifluoro-monochloropentane.

8. The thermosetting foamable composition of claim 7 wherein said trifluoro monochloropentane HCFO-1233zd.

9. The thermosetting foamable composition of claim 8 wherein said HCFO-1233zd is about 90 wt % or more the trans stereoisomer.

10. The thermosetting foamable composition of claim 8 wherein said HCFO-1233zd is about 97 wt % or more the trans stereoisomer.

11. The thermosetting foam composition of claim 8, further comprising an additional blowing agent selected from the group consisting of hydrofluorocarbons, hydrofluoroolefins, hydrochlorofluoroolefins and mixtures thereof.
